(19) United States
(12) Patent Application Publication
(10) Pub. No.: US 2024/0336845 A1
(43) Pub. Date: Oct. 10, 2024

(54) FILM, MANUFACTURING METHOD OF FILM, AND LAMINATE

(71) Applicant: FUJIFILM Corporation, Tokyo (JP)

(72) Inventors: Shohei YAMAZAKI, Kanagawa (JP); Yasuyuki SASADA, Kanagawa (JP); Miyoko HARA, Kanagawa (JP)

(73) Assignee: FUJIFILM Corporation, Tokyo (JP)

(21) Appl. No.: 18/749,541

(22) Filed: Jun. 20, 2024

Related U.S. Application Data
(63) Continuation of application No. PCT/JP2022/044971, filed on Dec. 6, 2022.

(30) Foreign Application Priority Data
Dec. 27, 2021 (JP) 2021-213451

(51) Int. Cl. C09K 19/38

(52) U.S. Cl. CPC C09K 19/3809; C09K 2219/03; C09K 2323/04

(57) ABSTRACT

A film having a phase-separated structure including at least two phases, in which a first phase which is one of the at least two phases contains a first liquid crystal polyester, a second phase which is one of the at least two phases and is different from the first phase contains a second liquid crystal polyester different from the first liquid crystal polyester, and a density is 1.2 g/cm³ or less; and applications thereof are provided.

### CROSS-REFERENCE TO RELATED APPLICATIONS

This application is a continuation application of International Application No. PCT/JP2022/044971, filed Dec. 6, 2022, the disclosure of which is incorporated herein by reference in its entirety. Further, this application claims priority from Japanese Patent Application No. 2021-213451, filed Dec. 27, 2021, the disclosure of which is incorporated herein by reference in its entirety.

### BACKGROUND OF THE INVENTION

### 1. Field of the Invention

The present disclosure relates to a film, a manufacturing method of a film, and a laminate.

### 2. Description of the Related Art

In recent years, frequencies used in communication equipment tend to be extremely high. In order to suppress transmission loss in a high frequency band, insulating materials used in a circuit board are required to have a lowered relative permittivity and a lowered dielectric loss tangent.

In the related art, polyimide is commonly used as the insulating material used in the circuit board, a liquid crystal polymer which has high heat resistance and low water absorption and is small in transmission loss in the high frequency band has been attracted.

For example, JP2021-095520A discloses a liquid crystal polyester film formed from a solution of a liquid composition containing a solvent and a liquid crystal polyester dissolved in the solvent, in which a concentration of solid contents is increased by containing the same or the same type of liquid crystal polyester powder as the liquid crystal polyester. In addition, WO2021-166879A discloses a film of a composite consisting of a liquid crystal polyester which is soluble in a solvent, and liquid crystal polymer particles which are insoluble in a solvent, have a melting point of 270° C. or higher, have a cumulative distribution 50% diameter D50 of 20 μm or less and a cumulative distribution 90% diameter D90 of 2.5 times or less the D50 in a particle size distribution.

### SUMMARY OF THE INVENTION

According to aspects of the present invention, there are provided a film having a low relative permittivity, a manufacturing method of a film, and a laminate.

The methods for achieving the above-described objects include the following aspects.
<1> A film, comprising:
a phase-separated structure comprising at least two phases,
in which a first phase which is one of the at least two phases comprises a first liquid crystal polyester,
a second phase which is one of the at least two phases and is different from the first phase comprises a second liquid crystal polyester different from the first liquid crystal polyester, and
a density of the film is 1.2 g/cm³ or less.
<2> The film according to <1>,
in which the first liquid crystal polyester comprises an aromatic polyester amide.
<3> The film according to <1> or <2>,
in which at least a part of the second liquid crystal polyester in the second phase is present in a particle form.
<4> The film according to <3>,
in which a content of the second liquid crystal polyester is 40% by volume or more with respect to a total volume of the film.
<5> The film according to <3> or <4>,
in which a melting point of the second liquid crystal polyester is higher than a melting point of the first liquid crystal polyester.
<6> A laminate comprising:
the film according to any one of <1> to <5>; and
a metal layer or a metal wire, disposed on at least one surface of the film.
<7> A manufacturing method of a film, comprising:
preparing a dispersion liquid comprising a first liquid crystal polyester, a second liquid crystal polyester different from the first liquid crystal polyester, and a solvent;
producing a precursor comprising a substrate and a cured film of the dispersion liquid, which is formed on the substrate; and
heating the precursor to form a film on the substrate,
in which the film has a density of 1.2 g/cm³ or less, and has a phase-separated structure comprising at least two phases.
<8> The manufacturing method of a film according to <7>,
in which the film is formed by heating the precursor and then cooling the precursor at a cooling rate of 50° C./min or less.

According to the aspects of the present invention, there are provided a film having a low relative permittivity, a manufacturing method of a film, and a laminate.

### DESCRIPTION OF THE PREFERRED EMBODIMENTS

Hereinafter, the contents of the present disclosure will be described in detail. The description of configuration requirements below is made based on representative embodiments of the present disclosure in some cases, but the present disclosure is not limited to such embodiments.
Further, in the present specification, a numerical range shown using “to” indicates a range including numerical values described before and after “to” as a lower limit and an upper limit.
In a numerical range described in a stepwise manner in the present disclosure, an upper limit or a lower limit described in one numerical range may be replaced with an upper limit or a lower limit in another numerical range described in a stepwise manner. Further, in a numerical range described in the present disclosure, an upper limit or a lower limit described in the numerical range may be replaced with a value described in an example.
Further, in a case where substitution or unsubstitution is not noted in regard to the notation of a “group” (atomic group) in the present specification, the “group” includes not only a group that does not have a substituent but also a group having a substituent. For example, the concept of an “alkyl group” includes not only an alkyl group that does not have a substituent (unsubstituted alkyl group) but also an alkyl group having a substituent (substituted alkyl group).
Furthermore, in the present disclosure, a combination of two or more preferred embodiments is a more preferred embodiment.
Further, the weight-average molecular weight (Mw) and the number-average molecular weight (Mn) in the present disclosure are molecular weights converted using polystyrene as a standard substance by performing detection with a gel permeation chromatography (GPC) analysis apparatus using TSKgel SuperHM-H (trade name, manufactured by Tosoh Corporation) column, a solvent of pentafluorophenol (PFP) and chloroform at a mass ratio of 1:2, and a differential refractometer, unless otherwise specified.

### Film

The film according to the present disclosure has a phase-separated structure including at least two phases, in which a first phase which is one of the at least two phases contains a first liquid crystal polyester, a second phase which is one of the at least two phases and is different from the first phase contains a second liquid crystal polyester different from the first liquid crystal polyester, and a density is 1.2 g/cm³ or less.

As a result of intensive studies, the present inventor has found that a film having a low relative permittivity can be provided by adopting the above-described configuration.

The detailed mechanism for obtaining the above-described effects is not clear, but assumed as follows.

Since the density of the film according to the present disclosure is 1.2 g/cm³ or less, a relative permittivity is low. It is known that the density of the liquid crystal polyester itself is generally more than 1.2 g/cm³ and 1.4 g/cm³ or less. The film according to the present disclosure contains at least two kinds of liquid crystal polyesters, but the density of the film is lower than the density of the liquid crystal polyester itself. This is because, in the film, at least two kinds of liquid crystal polyesters having low compatibility with each other coexist in a state in which they are phase-separated and have a large free volume (for example, a state in which one of the liquid crystal polyesters is buried in the other or in a gap between the other, or a state in which one of the liquid crystal polyesters is dispersed in the other).

On the other hand, JP2021-095520A discloses a film containing two kinds of liquid crystal polyesters having compatibility, but does not focus on the phase-separated structure. In addition, from the manufacturing method, it is considered that the film disclosed in WO2021-166879A does not increase the free volume of the liquid crystal polyesters and is the same as the density of the polyester itself.

The film according to the present disclosure has a phase-separated structure including at least two phases. In the present disclosure, the “phase-separated structure” means a structure in which at least two portions containing components different from each other are present in the film.

Examples of the phase-separated structure include a sea-island structure, a co-continuous structure, a cylinder structure, and a lamella structure. Among these, the phase-separated structure in the film according to the present disclosure is preferably a sea-island structure. The sea-island structure means a structure in which one phase of the at least two phases forms a continuous phase and the other phase is dispersed in a discontinuous manner.

The fact that the film has a phase-separated structure can be confirmed by a method of observing a morphology, evaluating a material distribution, evaluating a mechanical property distribution, or the like for the film surface, the film cross section, or both the film surface and the film cross section. In the present disclosure, in a case where the phase-separated structure can be confirmed by any one of the method of the morphological observation, the method of the material distribution evaluation, or the method of the mechanical property distribution evaluation, it is determined that the film has a phase-separated structure.
The morphological observation is performed using a known optical microscope. In a case where the morphological observation cannot be performed using a known optical microscope, the morphological observation is performed using an electron microscope or the like.
The material distribution evaluation is performed by imaging of an infrared spectroscopy. In a case where the infrared spectroscopy cannot be imaged, imaging of the Raman spectroscopy is used. In a case where the Raman spectroscopy cannot be imaged, imaging of the X-ray photoelectron spectroscopy is used.
The mechanical property distribution evaluation is performed using an atomic force microscope or the like.

### First Phase

The film according to the present disclosure has a phase-separated structure including at least two phases. The first phase which is one of the at least two phases contains a first liquid crystal polyester.

In the present disclosure, the “liquid crystal polyester” is a concept including a liquid crystal polyester and a compound in which a bond other than an ester bond is introduced into the liquid crystal polyester. Examples of the liquid crystal polyester include a liquid crystal polyester, a liquid crystal polyester amide in which an amide bond is introduced into the liquid crystal polyester, a liquid crystal polyester ether in which an ether bond is introduced into the liquid crystal polyester, and a liquid crystal polyester carbonate in which a carbonate bond is introduced into the liquid crystal polyester.

From the viewpoint of reducing the relative permittivity, the first liquid crystal polyester preferably includes a liquid crystal polyester having an aromatic ring, more preferably includes an aromatic polyester or an aromatic polyester amide, still more preferably includes an aromatic polyester amide, and particularly preferably contains a fully aromatic polyester amide.

Examples of the first liquid crystal polyester include the following compounds.
1) a liquid crystal polymer obtained by polycondensing (i) an aromatic hydroxycarboxylic acid, (ii) an aromatic dicarboxylic acid, and (iii) at least one compound selected from the group consisting of an aromatic diol, an aromatic hydroxyamine, and an aromatic diamine;
2) a liquid crystal polymer obtained by polycondensing a plurality of types of aromatic hydroxycarboxylic acids;
3) a liquid crystal polymer obtained by polycondensing (i) an aromatic dicarboxylic acid and (ii) at least one compound selected from the group consisting of an aromatic diol, an aromatic hydroxyamine, and an aromatic diamine;
4) a liquid crystal polymer obtained by polycondensing (i) polyester such as polyethylene terephthalate and (ii) an aromatic hydroxycarboxylic acid.
Here, the aromatic hydroxycarboxylic acid, the aromatic dicarboxylic acid, the aromatic diol, the aromatic hydroxyamine, and the aromatic diamine may be each independently replaced with a polycondensable derivative.

For example, the aromatic hydroxycarboxylic acid and the aromatic dicarboxylic acid can be replaced with aromatic hydroxycarboxylic acid ester and aromatic dicarboxylic acid ester, by converting a carboxy group into an alkoxycarbonyl group or an aryloxycarbonyl group.
The aromatic hydroxycarboxylic acid and the aromatic dicarboxylic acid can be replaced with aromatic hydroxycarboxylic acid halide and aromatic dicarboxylic acid halide, by converting a carboxy group into a haloformyl group.
The aromatic hydroxycarboxylic acid and the aromatic dicarboxylic acid can be replaced with aromatic hydroxycarboxylic acid anhydride and aromatic dicarboxylic acid anhydride, by converting a carboxy group into an acyloxycarbonyl group.
Examples of a polymerizable derivative of a compound having a hydroxy group, such as an aromatic hydroxycarboxylic acid, an aromatic diol, and an aromatic hydroxyamine, include a derivative (acylated product) obtained by acylating a hydroxy group and converting the acylated group into an acyloxy group.
For example, the aromatic hydroxycarboxylic acid, the aromatic diol, and the aromatic hydroxyamine can be each replaced with an acylated product by acylating a hydroxy group and converting the acylated group into an acyloxy group.
Examples of a polymerizable derivative of a compound having an amino group, such as an aromatic hydroxyamine or an aromatic diamine, include a derivative (acylated product) obtained by acylating an amino group and converting the acylated group to an acylamino group.
For example, the aromatic hydroxyamine and the aromatic diamine can be each replaced with an acylated product by acylating an amino group and converting the acylated group into an acylamino group.

It is preferable that the first liquid crystal polyester includes a constitutional unit represented by Formula 1, a constitutional unit represented by Formula 2, and a constitutional unit represented by Formula 3.

—O—Ar¹—CO Formula 1

—CO—Ar²—CO Formula 2

—NH—Ar³—O Formula 3
In Formula 1 to Formula 3, Ar¹, Ar², and Ar³ each independently represent a phenylene group, a naphthylene group, or a biphenylylene group.
Hereinafter, the constitutional unit represented by Formula 1 and the like are also referred to as “unit 1” and the like.

The unit 1 can be introduced, for example, using aromatic hydroxycarboxylic acid as a raw material.
The unit 2 can be introduced, for example, using aromatic dicarboxylic acid as a raw material.
The unit 3 can be introduced, for example, using aromatic hydroxylamine as a raw material.

Here, the aromatic hydroxycarboxylic acid, the aromatic dicarboxylic acid, the aromatic diol, and the aromatic hydroxylamine may be each independently replaced with a polycondensable derivative.

For example, the aromatic hydroxycarboxylic acid and the aromatic dicarboxylic acid can be replaced with aromatic hydroxycarboxylic acid ester and aromatic dicarboxylic acid ester, by converting a carboxy group into an alkoxycarbonyl group or an aryloxycarbonyl group.
The aromatic hydroxycarboxylic acid and the aromatic dicarboxylic acid can be replaced with aromatic hydroxycarboxylic acid halide and aromatic dicarboxylic acid halide, by converting a carboxy group into a haloformyl group.
The aromatic hydroxycarboxylic acid and the aromatic dicarboxylic acid can be replaced with aromatic hydroxycarboxylic acid anhydride and aromatic dicarboxylic acid anhydride, by converting a carboxy group into an acyloxycarbonyl group.
Examples of a polymerizable derivative of a compound having a hydroxy group, such as an aromatic hydroxycarboxylic acid and an aromatic hydroxyamine, include a derivative (acylated product) obtained by acylating a hydroxy group and converting the acylated group into an acyloxy group.
For example, the aromatic hydroxycarboxylic acid and the aromatic hydroxylamine can be each replaced with an acylated product by acylating a hydroxy group and converting the acylated group into an acyloxy group.
Examples of a polycondensable derivative of the aromatic hydroxylamine include a substance (acylated product) obtained by acylating an amino group to convert the amino group into an acylamino group.
For example, the aromatic hydroxyamine can be replaced with an acylated product by acylating an amino group and converting the acylated group into an acylamino group.

In Formula 1, Ar¹ is preferably a p-phenylene group, a 2,6-naphthylene group, or a 4,4′-biphenylylene group, and more preferably a 2,6-naphthylene group.

In a case where Ar¹ is a p-phenylene group, the unit 1 is, for example, a constitutional unit derived from p-hydroxybenzoic acid.
In a case where Ar¹ is a 2,6-naphthylene group, the unit 1 is, for example, a constitutional unit derived from 6-hydroxy-2-naphthoic acid.
In a case where Ar¹ is a 4,4′-biphenylylene group, the unit 1 is, for example, a constitutional unit derived from 4′-hydroxy-4-biphenylcarboxylic acid.

In Formula 2, Ar² is preferably a p-phenylene group, an m-phenylene group, or a 2,6-naphthylene group, and more preferably an m-phenylene group.

In a case where Ar² is a p-phenylene group, the unit 2 is, for example, a constitutional unit derived from terephthalic acid.
In a case where Ar² is an m-phenylene group, the unit 2 is, for example, a constitutional unit derived from isophthalic acid.
In a case where Ar² is a 2,6-naphthylene group, the unit 2 is, for example, a constitutional unit derived from 2,6-naphthalenedicarboxylic acid.

In Formula 3, Ar³ is preferably a p-phenylene group or a 4,4′-biphenylylene group, and more preferably a p-phenylene group.

In a case where Ar³ is a p-phenylene group, the unit 3 is, for example, a constitutional unit derived from p-aminophenol.
In a case where Ar³ is a 4,4′-biphenylylene group, the unit 3 is, for example, a constitutional unit derived from 4-amino-4′-hydroxybiphenyl.

With respect to the total content of the unit 1, the unit 2, and the unit 3, a content of the unit 1 is preferably 30 mol % or more, a content of the unit 2 is preferably 35% or less, and a content of the unit 3 is preferably 35 mol % or less.
The content of the unit 1 is preferably 30 mol % to 80 mol %, more preferably 30 mol % to 60 mol %, and particularly preferably 30 mol % to 40 mol % with respect to the total content of the unit 1, the unit 2, and the unit 3.
The content of the unit 2 is preferably 10 mol % to 35 mol %, more preferably 20 mol % to 35 mol %, and particularly preferably 30 mol % to 35 mol % with respect to the total content of the unit 1, the unit 2, and the unit 3.
The content of the unit 3 is preferably 10 mol % to 35 mol %, more preferably 20 mol % to 35 mol %, and particularly preferably 30 mol % to 35 mol % with respect to the total content of the unit 1, the unit 2, and the unit 3.
The total content of the constitutional units is a value obtained by totaling a substance amount (mol) of each constitutional unit. The substance amount of each constitutional unit is calculated by dividing a mass of each constitutional unit constituting the first liquid crystal polyester by a formula weight of each constitutional unit.

In a case where a ratio of the content of the unit 2 to the content of the unit 3 is expressed as [Content of unit 2]/[Content of unit 3] (mol/mol), the ratio is preferably 0.9/1 to 1/0.9, more preferably 0.95/1 to 1/0.95, and still more preferably 0.98/1 to 1/0.98.

The first liquid crystal polyester may have two kinds or more of each of the unit 1 to the unit 3 independently. In addition, the first liquid crystal polyester may have other constitutional units in addition to the unit 1 to the unit 3. A content of other constitutional units is preferably 10% by mole or less and more preferably 5% by mole or less with respect to the total content of all constitutional units.

The first liquid crystal polyester is preferably produced by melt-polymerizing raw material monomers corresponding to the constitutional units constituting the first liquid crystal polyester.

A melting point of the first liquid crystal polyester is preferably 250° C. or higher, more preferably 250° C. to 350° C., and still more preferably 260° C. to 330° C.

The melting point is measured using a differential scanning calorimetry apparatus.

A weight-average molecular weight of the first liquid crystal polyester is preferably 1,000,000 or less, more preferably 3,000 to 300,000, still more preferably 5,000 to 100,000, and particularly preferably 5,000 to 30,000.

A solubility of the first liquid crystal polyester in N-methylpyrrolidone is preferably 1% by mass or more, more preferably 2% by mass or more, still more preferably 3% by mass or more, and particularly preferably 5% by mass or more.

The first phase may contain only one kind of the first liquid crystal polyester, or may contain two or more kinds thereof.
A content of the first liquid crystal polyester is preferably 50% by mass or more, more preferably 70% by mass or more, and still more preferably 90% by mass or more with respect to the total amount of the first phase. The upper limit value of the content of the first liquid crystal polyester is not particularly limited, and may be 100% by mass.

The first phase may contain other components in addition to the first liquid crystal polyester within a range in which the effect of the present disclosure is not significantly impaired.
Known additives can be used as other components. Examples of the other components include a leveling agent, an antifoaming agent, an antioxidant, an ultraviolet absorbing agent, a flame retardant, and a colorant.

### Second Phase

The film according to the present disclosure has a phase-separated structure including at least two phases. The second phase which is one of the at least two phases and is different from the first phase contains a second liquid crystal polyester different from the first liquid crystal polyester. From the viewpoint of obtaining a film which has a phase-separated structure including at least two phases, it is preferable that the second liquid crystal polyester is different from the first liquid crystal polyester in terms of solubility in a solvent.

The second liquid crystal polyester may be any liquid crystal polyester as long as it is different from the first liquid crystal polyester, and the structure thereof is not particularly limited. As the second liquid crystal polyester, a compound different from the first liquid crystal polyester can be appropriately selected from the same compounds as the first liquid crystal polyester.

The second liquid crystal polyester is preferably produced by melt-polymerizing raw material monomers corresponding to the constitutional units constituting the second liquid crystal polyester.

A melting point of the second liquid crystal polyester is preferably 250° C. or higher, more preferably 250° C. to 350° C., and still more preferably 260° C. to 330° C.

A weight-average molecular weight of the second liquid crystal polyester is preferably 1,000,000 or less, more preferably 3,000 to 300,000, still more preferably 5,000 to 100,000, and particularly preferably 5,000 to 30,000.

A solubility of the second liquid crystal polyester in N-methylpyrrolidone is preferably less than 1% by mass, more preferably 0.5% by mass or less, and still more preferably 0.1% by mass or less.

It is preferable that the melting point of the second liquid crystal polyester is higher than the melting point of the first liquid crystal polyester.

The melting point Tm can be measured using a differential scanning calorimetry (DSC) device. A sample is taken from each of at least two phases which are phase-separated in the film. In a case where 5 mg of the sample is put into a measurement pan of the DSC and the sample is heated from 30° C. at 10° C./min in a nitrogen stream, a midpoint of an endothermic peak appearing in this case can be defined as Tm.

In a case where the melting point of the second liquid crystal polyester is higher than the melting point of the first liquid crystal polyester, the second liquid crystal polyester cannot follow volume contraction of the first liquid crystal polyester having high fluidity in a cooling process after annealing, and thus a free volume of the first liquid crystal polyester is increased. By increasing the free volume of the first liquid crystal polyester, the density of the film is decreased, and the relative permittivity is further reduced.

In the second phase, it is preferable that at least a part of the second liquid crystal polyester is present in a particle form. In a case where the second liquid crystal polyester is present in a particle form, for example, the first liquid crystal polyester can form a structure in which the first liquid crystal polyester is embedded in a gap between the particles of the second liquid crystal polyester. As a result, the first liquid crystal polyester is present in a state of having a large free volume, and a lower relative permittivity is obtained. Whether or not the second liquid crystal polyester is present in a particle form can be determined by observing a cross section of the film with a scanning electron microscope (SEM).

A median diameter (D50) of the second liquid crystal polyester is not particularly limited, but from the viewpoint of dispersibility and tensile strength, it is preferably 0.01 μm to 100 μm, more preferably 0.05 μm to 50 μm, still more preferably 0.1 μm to 30 μm, and particularly preferably 1 μm to 20 μm.

The second phase may contain only one kind of the second liquid crystal polyester, or may contain two or more kinds thereof.
A content of the second liquid crystal polyester is preferably 50% by mass or more, more preferably 70% by mass or more, and still more preferably 90% by mass or more with respect to the total amount of the second phase. The upper limit value of the content of the second liquid crystal polyester is not particularly limited, and may be 100% by mass.

The second phase may contain other components in addition to the second liquid crystal polyester within a range in which the effect of the present disclosure is not significantly impaired.
Known additives can be used as other components. Examples of the other components include a leveling agent, an antifoaming agent, an antioxidant, an ultraviolet absorbing agent, a flame retardant, and a colorant.

From the viewpoint of reducing the relative permittivity, the content of the second liquid crystal polyester is preferably 40% by volume or more, and more preferably 50% by volume or more with respect to the total volume of the film. The upper limit value of the content of the second liquid crystal polyester is, for example, 95% by volume.

### Physical Properties

The density of the film according to the present disclosure is 1.2 g/cm³ or less, preferably 1.1 g/cm³ or less, and more preferably 1.0 g/cm³ or less. The lower limit value of the density of the film is, for example, 0.3 g/cm³.

It is known that the density of the liquid crystal polyester itself is generally more than 1.2 g/cm³ and 1.4 g/cm³ or less. The film according to the present disclosure contains at least two kinds of liquid crystal polyesters, but the density of the film is lower than the density of the liquid crystal polyester itself.

The density of the film can be calculated based on the mass and volume of the film.

From the viewpoint of strength, dielectric loss tangent, and adhesiveness with a metal layer, a thickness of the film according to the present disclosure is preferably 6 μm to 200 μm, more preferably 12 μm to 100 μm, and particularly preferably 20 μm to 60 μm.

The thickness of the film is measured at any five places using an adhesive film thickness meter. The measurement is performed, for example, using an electronic micrometer (product name “KG3001A”, manufactured by Anritsu Corporation) as a film thickness meter, and an average value of the measured values is employed.

### Manufacturing Method of Film

The film according to the present disclosure is manufactured by, for example, a manufacturing method including a step of preparing a dispersion liquid containing a first liquid crystal polyester, a second liquid crystal polyester different from the first liquid crystal polyester, and a solvent (hereinafter, also referred to as “dispersion liquid preparation step”), a step of producing a precursor including a substrate and a cured film of the dispersion liquid, which is formed on the substrate (hereinafter, also referred to as “precursor production step”), and a step of heating the precursor to form a film on the substrate (hereinafter, also referred to as “film formation step”).
The film manufactured by the manufacturing method of the film according to the present disclosure has a density of 1.2 g/cm³ or less, and has a phase-separated structure including at least two phases.

Hereinafter, each step in the manufacturing method will be described.

### Dispersion Liquid Preparation Step

The manufacturing method of the film according to the present disclosure includes a step of preparing a dispersion liquid containing the first liquid crystal polyester, the second liquid crystal polyester, and a solvent.

Preferred aspects of the first liquid crystal polyester and the second liquid crystal polyester, which are contained in the dispersion liquid prepared in the dispersion liquid preparation step, are the same as the preferred aspects of the first liquid crystal polyester and the second liquid crystal polyester, which are contained in the above-described film.

From the viewpoint of obtaining a film which has a phase-separated structure including at least two phases, it is preferable that the first liquid crystal polyester is dissolved in the solvent contained in the dispersion liquid, and the second liquid crystal polyester is insoluble in the solvent contained in the dispersion liquid.

In the dispersion liquid, it is preferable that the first liquid crystal polyester is present in a dissolved state in the solvent, and the second liquid crystal polyester is present in a non-dissolved state in the solvent and in a dispersed state in a particle form.

Examples of the solvent contained in the dispersion liquid include halogenated hydrocarbons such as dichloromethane, chloroform, 1,1-dichloroethane, 1,2-dichloroethane, 1,1,2,2-tetrachloroethane, 1-chlorobutane, chlorobenzene, and o-dichlorobenzene; halogenated phenols such as p-chlorophenol, pentachlorophenol, and pentafluorophenol; ethers such as diethyl ether, tetrahydrofuran, and 1,4-dioxane; ketones such as acetone and cyclohexanone; esters such as ethyl acetate and γ-butyrolactone; carbonates such as ethylene carbonate and propylene carbonate; amines such as triethylamine; nitrogen-containing heterocyclic aromatic compounds such as pyridine; nitriles such as acetonitrile and succinonitrile; amides such as N,N-dimethylformamide, N,N-dimethylacetamide, and N-methylpyrrolidone; urea compounds such as tetramethylurea; nitro compounds such as nitromethane and nitrobenzene; sulfur compounds such as dimethyl sulfoxide and sulfolane; and phosphorus compounds such as hexamethylphosphoramide and tri-n-butyl phosphate.

The solvent is preferably a solvent containing, as a main component, an aprotic compound, particularly, an aprotic compound having no halogen atom for low corrosiveness and easiness to handle. A proportion of the aprotic compound to the whole solvent is preferably 50% by mass to 100% by mass, more preferably 70% by mass to 100% by mass, and particularly preferably 90% by mass to 100% by mass. In addition, from the viewpoint of easily dissolving the liquid crystal polymer, as the above-described aprotic compound, an amide such as N,N-dimethylformamide, N,N-dimethylacetamide, tetramethylurea, and N-methylpyrrolidone, or an ester such as γ-butyrolactone is preferable; and N,N-dimethylformamide, N,N-dimethylacetamide, or N-methylpyrrolidone is more preferable.

### Precursor Production Step

The manufacturing method of the film according to the present disclosure includes a step of producing a precursor including a substrate and a cured film of the dispersion liquid, which is formed on the substrate.

The type of the substrate is not particularly limited, but in a case where a laminate described later (specifically, a laminate including a film and a metal layer disposed on the film) is assumed to be produced, a metal substrate is preferable. A metal constituting the metal substrate is preferably copper.

A thickness of the substrate is not particularly limited, but is preferably 1 μm to 50 μm and more preferably 5 μm to 25 μm.

In the precursor production step, for example, the dispersion liquid is applied onto the substrate, and then dried. Examples of a method of applying the dispersion liquid include a casting method and a coating method. A drying method is not particularly limited, and the drying may be performed by natural drying or by heating and drying using hot air or the like. The dispersion liquid is dried to remove the solvent, thereby forming a cured film of the dispersion liquid on the substrate. In the cured film of the dispersion liquid, it is preferable that the first liquid crystal polyester soluble in the solvent is present as a matrix, and the second liquid crystal polyester insoluble in the solvent is present in a dispersed state in the matrix.

A thickness of the cured film of the dispersion liquid is not particularly limited, but is preferably 5 μm to 200 μm and more preferably 10 μm to 100 μm.

In the precursor production step, the cured film of the dispersion liquid may be directly formed on a surface of the substrate, or other layers may be provided on the substrate and then the cured film of the dispersion liquid may be formed on a surface of the other layer.

Examples of the other layers include an adhesive layer and a peeling layer. The other layers are appropriately selected according to the purpose.

### Film Formation Step

The manufacturing method of the film according to the present disclosure includes a step of heating the precursor to form a film on the substrate. The cured film of the dispersion liquid is heated to form a film.

In the film formation step, a heating temperature in a case of heating the precursor is preferably 100° C. to 400° C. In addition, a heating time in a case of heating the precursor is preferably 0.1 minutes to 10 hours. The heating temperature and the heating time can be appropriately changed according to the types of the first liquid crystal polyester and the second liquid crystal polyester, and can also be lowered or shortened by another method such as addition of a catalyst.

From the viewpoint of reducing the dielectric loss tangent, the film formation step is preferably performed in an inert gas atmosphere.

It is preferable to heat the precursor and then cool the precursor at a cooling rate of 50° C./min or less. The cooling rate is more preferably 5° C./min or less and still more preferably 2° C./min or less. The lower limit value of the cooling rate is, for example, 0.1° C./min.

In a generally known cooling method, the cooling rate exceeds 50° C./min. In the method for manufacturing the film according to the present disclosure, it is considered that, in a case where the precursor is heated and then cooled, since the cooling rate is low, the volume contraction of the first liquid crystal polyester and the second liquid crystal polyester is large. It is considered that, with the volume contraction, the free volume of the first liquid crystal polyester present as a matrix increases, and thus the density of the film decreases.

The manufacturing method of the film according to the present disclosure may include, after the film formation step, a step of peeling the film from the substrate. The film can be applied to other applications by peeling the film from the substrate.

### Laminate

It is preferable that the laminate according to the present disclosure includes the above-described film and a metal layer or a metal wire, disposed on at least one surface of the film.

The metal layer or the metal wire may be a known metal layer or metal wire, but is preferably a copper layer or a copper wire.

As the copper layer, a rolled copper foil formed by a rolling method or an electrolytic copper foil formed by an electrolytic method is preferable.

The laminate may be manufactured by laminating the film and the metal layer.
A method of laminating the film and the metal layer is not particularly limited, and a known laminating method can be used.

In addition, a metal substrate is used as the substrate in the manufacturing method of the film described above, whereby the laminate can be manufactured without peeling the film from the substrate.

A thickness of the metal layer is not particularly limited, but is preferably 3 μm to 30 μm and more preferably 5 μm to 20 μm.

The thickness of the metal layer is calculated by the following method.
The laminate is cut with a microtome, and a cross section is observed with an optical microscope. Three or more cross-sectional samples are cut, and a thickness of a layer to be measured in each cross section is measured at three points or more. An average value of the measured values is calculated and adopted as the average thickness.

It is preferable that the metal layer in the laminate according to the embodiment of the present disclosure is processed into, for example, a desired circuit pattern by etching to form a flexible printed circuit board. The etching method is not particularly limited, and a known etching method can be used.

### EXAMPLES

Hereinafter, the present disclosure will be described in more detail using Examples. However, the present disclosure is not limited to the following examples as long as it does not exceed the gist of the present invention.

### Synthesis of Aromatic Polyester Amide

940.9 g (5.0 mol) of 6-hydroxy-2-naphthoic acid, 415.3 g (2.5 mol) of isophthalic acid, 377.9 g (2.5 mol) of acetaminophen, and 867.8 g (8.4 mol) of acetic acid anhydride were added to a reactor provided with a stirrer, a torque meter, a nitrogen gas introduction pipe, a thermometer, and a reflux condenser, the gas inside the reactor was replaced with nitrogen gas, and the mixture was heated from room temperature (23° C.; the same applies hereinafter) to 140° C. over 60 minutes while being stirred in a nitrogen gas stream and was refluxed at 140° C. for 3 hours.
Next, the temperature was raised from 150° C. to 300°° C. over 5 hours while distilling off by-produced acetic acid and unreacted acetic acid anhydride, and maintained at 300° C. for 30 minutes. Thereafter, the content was taken out from the reactor and was cooled to room temperature. The obtained solid was pulverized by a pulverizer to obtain a powdered aromatic polyester amide A1a. A flow start temperature of the aromatic polyester amide A1a was 193° C. In addition, the aromatic polyester amide A1a was a fully aromatic polyester amide.
The aromatic polyester amide A1a was subjected to solid polymerization by increasing the temperature from room temperature to 160° C. over 2 hours and 20 minutes in a nitrogen atmosphere, increasing the temperature from 160° C. to 180° C. over 3 hours and 20 minutes, and maintaining the temperature at 180° C. for 5 hours, and then the resultant was cooled. Next, the resultant was pulverized by a pulverizer to obtain a powdered aromatic polyester amide A1b. A flow start temperature of the aromatic polyester amide A1b was 220° C.
The aromatic polyester amide A1b was subjected to solid polymerization by increasing the temperature from room temperature to 180° C. over 1 hour and 25 minutes in a nitrogen atmosphere, increasing the temperature from 180° C. to 255° C. over 6 hours and 40 minutes, and maintaining the temperature at 255° C. for 5 hours, and then the resultant was cooled, thereby obtaining a powdered aromatic polyester amide A1.
A flow start temperature of the aromatic polyester amide A1 was 302° C. In addition, in a case where a melting point of the aromatic polyester amide A1 was measured using a differential scanning calorimetry device, the measured value was 311° C. The solubility of the aromatic polyester amide A1 in N-methylpyrrolidone was 1% by mass or more.

### Preparation of Solution of First Liquid Crystal Polyester

The above-described aromatic polyester amide A1 (80 g) was added to 920 g of N-methylpyrrolidone, and stirred at 140° C. for 4 hours in a nitrogen atmosphere. A solution of the first liquid crystal polyester A1 (aromatic polyester amide A1) in which the concentration of solid contents was 8.0% by mass was obtained.

### Synthesis of Second Liquid Crystal Polyester B1

1034.99 g (5.5 mol) of 2-hydroxy-6-naphthoic acid, 89.18 g (0.41 mol) of 2,6-naphthalenedicarboxylic acid, 236.06 g (1.42 mol) of terephthalic acid, 341.39 g (1.83 mol) of 4,4-dihydroxybiphenyl, and potassium acetate and magnesium acetate as a catalyst were put in a reactor including a stirring device, a torque meter, a nitrogen gas introduction pipe, a thermometer, and a reflux condenser. The gas in the reactor was replaced with nitrogen gas, and acetic anhydride (1.08 molar equivalent with respect to a hydroxyl group) was further added thereto. The temperature was raised from room temperature to 150° C. over 15 minutes while stirring in a nitrogen gas stream, and refluxing was performed at 150° C. for 2 hours.
Next, the temperature was raised from 150° C. to 310° C. over 5 hours while distilling off by-produced acetic acid and unreacted acetic acid anhydride, and a polymerized substance was cooled to room temperature. The obtained polymerized substance was heated from room temperature to 295° C. over 14 hours, and was subjected to solid polymerization at 295° C. for 1 hour. After the solid polymerization, the polymerized substance was cooled to room temperature to obtain a second liquid crystal polyester B1. The solubility of the second liquid crystal polyester B1 in N-methylpyrrolidone was less than 1% by mass.

### Production of Particles of Second Liquid Crystal Polyester B1

The second liquid crystal polyester B1 was pulverized using a jet mill (“KJ-200” manufactured by KURIMOTO, LTD.) to obtain particles of the second liquid crystal polyester B1. The obtained particles had a median diameter (D50) of 10 μm, a dielectric loss tangent of 0.0007, and a melting point of 319° C.

### Synthesis of Second Liquid Crystal Polyester B2

1034.99g (5.5 mol) of 2-hydroxy-6-naphthoic acid, 3012.05 g (21.8 mol) of 4-hydroxybenzoic acid, 13.71 g (0.08 mol) of terephthalic acid, and acetic anhydride and a metal catalyst as a catalyst are put in a reactor including a stirring device, a torque meter, a nitrogen gas introduction pipe, a thermometer, and a reflux condenser. After the gas in the reactor was replaced with nitrogen gas, the mixture was heated from room temperature to 140° C. over 15 minutes while being stirred in a nitrogen gas stream and was refluxed at 140°° C. for 1 hour.
Next, the temperature was raised from 150° C. to 330° C. over 3 hours and 30 minutes, pressure reduction was performed, and polymerization was performed while distilling off by-produced acetic acid and unreacted acetic anhydride. After the polymerization, the polymerized substance was cooled to room temperature to obtain a second liquid crystal polyester B2. The solubility of the second liquid crystal polyester B2 in N-methylpyrrolidone was less than 1% by mass.

### Production of Particles of Second Liquid Crystal Polyester B2

The second liquid crystal polyester B2 was pulverized using a jet mill (“KJ-200” manufactured by KURIMOTO, LTD.) to obtain particles of the second liquid crystal polyester B2.

### Example 1

The solution (40 g) of the first liquid crystal polyester A1 and the particles (3.2 g) of the second liquid crystal polyester B1 were mixed with each other. By the mixing, a dispersion liquid 1 containing, as a solid content, 60% by volume of the first liquid crystal polyester A1 and 40% by volume of the particles of the second liquid crystal polyester B1 was obtained.
The dispersion liquid 1 was applied onto an electrolytic copper foil (product name “CF-T9DA-SV-18”, manufactured by FUKUDA METAL FOIL & POWER CO., LTD.; surface roughness Sa=0.22 μm), and then dried at 50° C. for 3 hours. As a result, a precursor including the electrolytic copper foil and a cured film of the dispersion liquid 1, having a thickness of 25 μm, was obtained.
The precursor was subjected to an annealing treatment at 300° C. for 3 hours in a nitrogen atmosphere. After the annealing treatment, the precursor was cooled at a cooling rate of 1.5° C./min. A laminate (flexible copper-clad laminated plate) in which the film was formed on the electrolytic copper foil was obtained. The film included a phase consisting of the first liquid crystal polyester A1 and a phase consisting of the second liquid crystal polyester B1, and had a phase-separated structure.

### Example 2

The solution (40 g) of the first liquid crystal polyester A1 and the particles (9.6 g) of the second liquid crystal polyester BI were mixed with each other. By the mixing, a dispersion liquid 2 containing, as a solid content, 35% by volume of the first liquid crystal polyester A1 and 65% by volume of the particles of the second liquid crystal polyester B1 was obtained.
A flexible copper-clad laminated plate in which the film was formed on the electrolytic copper foil was obtained by the same method as in Example 1, except that the dispersion liquid 1 was changed to the dispersion liquid 2. The film included a phase consisting of the first liquid crystal polyester A1 and a phase consisting of the second liquid crystal polyester B1, and had a phase-separated structure.

### Example 3

The solution (40 g) of the first liquid crystal polyester A1 and the particles (3.2 g) of the second liquid crystal polyester B2 were mixed with each other. By the mixing, a dispersion liquid 3 containing, as a solid content, 60% by volume of the first liquid crystal polyester A1 and 40% by volume of the particles of the second liquid crystal polyester B2 was obtained.
A flexible copper-clad laminated plate in which the film was formed on the electrolytic copper foil was obtained by the same method as in Example 1, except that the dispersion liquid 1 was changed to the dispersion liquid 3. The film included a phase consisting of the first liquid crystal polyester A1 and a phase consisting of the second liquid crystal polyester B2, and had a phase-separated structure.

### Example 4

The solution (40 g) of the first liquid crystal polyester A1 and the particles (9.6 g) of the second liquid crystal polyester B2 were mixed with each other. By the mixing, a dispersion liquid 4 containing, as a solid content, 35% by volume of the first liquid crystal polyester A1 and 65% by volume of the particles of the second liquid crystal polyester B2 was obtained.
A flexible copper-clad laminated plate in which the film was formed on the electrolytic copper foil was obtained by the same method as in Example 1, except that the dispersion liquid 1 was changed to the dispersion liquid 4. The film included a phase consisting of the first liquid crystal polyester A1 and a phase consisting of the second liquid crystal polyester B2, and had a phase-separated structure.

### Comparative Example 1

A flexible copper-clad laminated plate in which the film was formed on the electrolytic copper foil was obtained by the same method as in Example 1, except that the dispersion liquid 1 was changed to the solution of the first liquid crystal polyester A1. The film contained the first liquid crystal polyester A1, and did not have a phase-separated structure.

Using the produced flexible copper-clad laminated plate, a density, a relative permittivity, and a dielectric loss tangent of the film were measured. The measuring methods were as follows. The measurement results are shown in Table 1.

### Density

A copper layer was etched from the produced flexible copper-clad laminated plate to take out a film. A strip-shaped test piece having a width of 1 cm and a length of 5 cm was cut out from the taken-out film.

A density p was calculated by the following expression.

$$ρ = w / ( A \times d )$$

In the expression, w is a mass (unit: g) of the test piece, d is a thickness (unit: cm) of the test piece, and A is a surface area (5 cm²) of the test piece.

### Relative Permittivity and Dielectric Loss Tangent

A copper layer was etched from the produced flexible copper-clad laminated plate to take out a film. A strip-shaped test piece having a width of 2 cm and a length of 80 mm was cut out from the taken-out film.
A relative permittivity and a dielectric loss tangent were measured by a resonant perturbation method at a frequency of 10 GHz. A 10 GHz cavity resonator (CP531 manufactured by Kanto Electronics Application & Development Inc.) was connected to a network analyzer (“E8363B” manufactured by Agilent Technology), the test piece was inserted into the cavity resonator, and the relative permittivity and the dielectric loss tangent of the film were measured based on a change in resonance frequency for 96 hours before and after the insertion in an environment of a temperature of 25° C. and a humidity of 60% RH.

TABLE 1

| | First phase | | Second phase | | | | |
|---|---|---|---|---|---|---|---|
| | First liquid | Content | Second liquid | Content | | | Dielectric |
| | crystal | (% by | crystal | (% by | Density | Relative | loss |
| | polyester | volume) | polyester | volume) | (g/cm³) | permittivity | tangent |
| Example 1 | A1 | 60 | B1 | 40 | 0.90 | 2.6 | 0.0031 |
| Example 2 | A1 | 35 | B1 | 65 | 0.85 | 2.3 | 0.0019 |
| Example 3 | A1 | 60 | B2 | 40 | 0.97 | 2.2 | 0.0032 |
| Example 4 | A1 | 35 | B2 | 65 | 0.99 | 2.3 | 0.0025 |
| Comparative | A1 | 100 | — | — | 1.38 | 3.5 | 0.0052 |
| Example 1 | | | | | | | |

As shown in Table 1, in Examples 1 to 4, since the film had a phase-separated structure including at least two phases, and the first phase which was one of the at least two phases contained the first liquid crystal polyester and the second phase which was one of the at least two phases and was different from the first phase contained the second liquid crystal polyester different from the first liquid crystal polyester, and the density was 1.2 g/cm³ or less, the result was that the relative permittivity was extremely low as compared with the related art.

On the other hand, in Comparative Example 1, the density of the film was more than 1.2 g/cm³, and the relative permittivity was high.

The disclosure of Japanese Patent Application No. 2021-213451 filed on Dec. 27, 2021 is incorporated in the present specification by reference. In addition, all documents, patent applications, and technical standards described in the present specification are incorporated herein by reference to the same extent as in a case of being specifically and individually noted that individual documents, patent applications, and technical standards are incorporated by reference.

What is claimed is:

1. A film, comprising:
a phase-separated structure comprising at least two phases,
wherein a first phase which is one of the at least two phases comprises a first liquid crystal polyester,
a second phase which is one of the at least two phases and is different from the first phase comprises a second liquid crystal polyester different from the first liquid crystal polyester, and
a density the film is 1.2 g/cm³ or less.

2. The film according to claim 1,
wherein the first liquid crystal polyester comprises an aromatic polyester amide.

3. The film according to claim 1,
wherein at least a part of the second liquid crystal polyester in the second phase is present in a particle form.

4. The film according to claim 3,
wherein a content of the second liquid crystal polyester is 40% by volume or more with respect to a total volume of the film.

5. The film according to claim 3,
wherein a melting point of the second liquid crystal polyester is higher than a melting point of the first liquid crystal polyester.

6. A laminate, comprising:
the film according to claim 1; and
a metal layer or a metal wire, disposed on at least one surface of the film.

7. A manufacturing method of a film, comprising:
preparing a dispersion liquid comprising a first liquid crystal polyester, a second liquid crystal polyester different from the first liquid crystal polyester, and a solvent;
producing a precursor comprising a substrate and a cured film of the dispersion liquid, which is formed on the substrate; and
heating the precursor to form a film on the substrate,
wherein the film has a density of 1.2 g/cm³ or less, and has a phase-separated structure comprising at least two phases.

8. The manufacturing method of a film according to claim 7,
wherein the film is formed by heating the precursor and then cooling the precursor at a cooling rate of 50° C./min or less.
